(19) United States
(12) Patent Application Publication
(10) Pub. No.: US 2026/0208539 A1
(43) Pub. Date: Jul. 23, 2026

(54) TIRE

(71) Applicant: The Yokohama Rubber Co., LTD., Kanagawa (JP)

(72) Inventor: Taiyo MORI, Kanagawa (JP)

(21) Appl. No.: 19/446,327

(22) Filed: Jan. 12, 2026

(30) Foreign Application Priority Data
Jan. 21, 2025 (JP) 2025-008296

(51) Int. Cl. B60C 11/12; B60C 11/00; B60C 11/03

(52) U.S. Cl. CPC B60C 11/1204; B60C 11/0008; B60C 11/1236; B60C 2011/0016; B60C 2011/0341; B60C 2011/1227; B60C 2011/1254

(57) ABSTRACT

Included in a tire are: in the tread portion, circumferential grooves extending along a tire circumferential direction and disposed side by side in a tire width direction; a center-portion land portion defined by the circumferential grooves and having a rib shape; closed sipes having both ends terminating at the tread surface of the center-portion land portion and disposed side by side in the tire circumferential direction; and a belt layer composed of belt plies disposed on an inner side of the closed sipes in a tire radial direction. An angle α of a straight line connecting both the ends of a closed sipe of the closed sipes with respect to the tire circumferential direction and a cord angle β of a belt cord of the belt ply on an outermost side in the tire radial direction with respect to the tire circumferential direction satisfy relationships β-40°≤α≤β and 10°≤β≤30°.

### CROSS-REFERENCE TO RELATED APPLICATION

This application claims priority pursuant to 35 U.S.C. 119(a) to Japanese Patent Office Application No. 2025-008296, filed January 21, 2025, which application is incorporated herein by reference in its entirety.

### TECHNICAL FIELD

The technology relates to a tire.

### BACKGROUND

In the related art, for example, Japanese Unexamined Patent Publications No’s. S62-247905 A and 2006-327320 A disclose a heavy duty tire in which a kerf or a sipe having both ends terminated is disposed in a rib disposed on a tread surface.

For example, a steering axle tire for long-haul operation mainly for high-speed continued traveling typically uses a rib pattern, and sipes are disposed in ribs of a central portion and a middle portion in consideration of traction performance. Such a tire may cause, due to the opening of the sipe during inflation or an increase in frictional energy around the sipe at the time of ground contact, uneven wear such as heel-and-toe wear or rib punching wear in which uneven wear spreads over the entire rib as the heel-and-toe wear progresses.

### SUMMARY

The technology provides a tire that can provide improved uneven wear resistance performance.

A tire according to one aspect of the present technology includes: in a tread portion, a plurality of circumferential grooves extending along a tire circumferential direction and disposed side by side in a tire width direction; a land portion defined by the circumferential grooves and having a rib shape; a plurality of closed sipes having both ends terminating at the tread surface of the land portion and disposed side by side in the tire circumferential direction; and a belt layer composed of a plurality of belt plies disposed on an inner side of the closed sipes in a tire radial direction. An angle α of a straight line connecting both the ends of a closed sipe of the closed sipes with respect to the tire circumferential direction and a cord angle β of a belt cord of a belt ply of the belt plies on an outermost side in the tire radial direction with respect to the tire circumferential direction satisfy relationships β - 40° ≤ α ≤ β and 10° ≤ β ≤ 30°.

The present technology allows uneven wear resistance to be improved.

### BRIEF DESCRIPTION OF DRAWINGS

FIG. 1 is a meridian cross-sectional view of a pneumatic tire according to an embodiment;

FIG. 2 is a plan view of a tread portion of the pneumatic tire according to an embodiment;

FIG. 3 is an explanatory diagram illustrating the definition of an angle of the pneumatic tire according to an embodiment;

FIG. 4 is a partial enlarged plan view of the tread portion of the pneumatic tire according to an embodiment;

FIG. 5 is a partial enlarged meridian cross-sectional view of the tread portion of the pneumatic tire according to an embodiment;

FIG. 6 is a table showing results of performance tests of pneumatic tires according to an embodiment;

FIG. 7 is a table showing results of performance tests of pneumatic tires according to an embodiment;

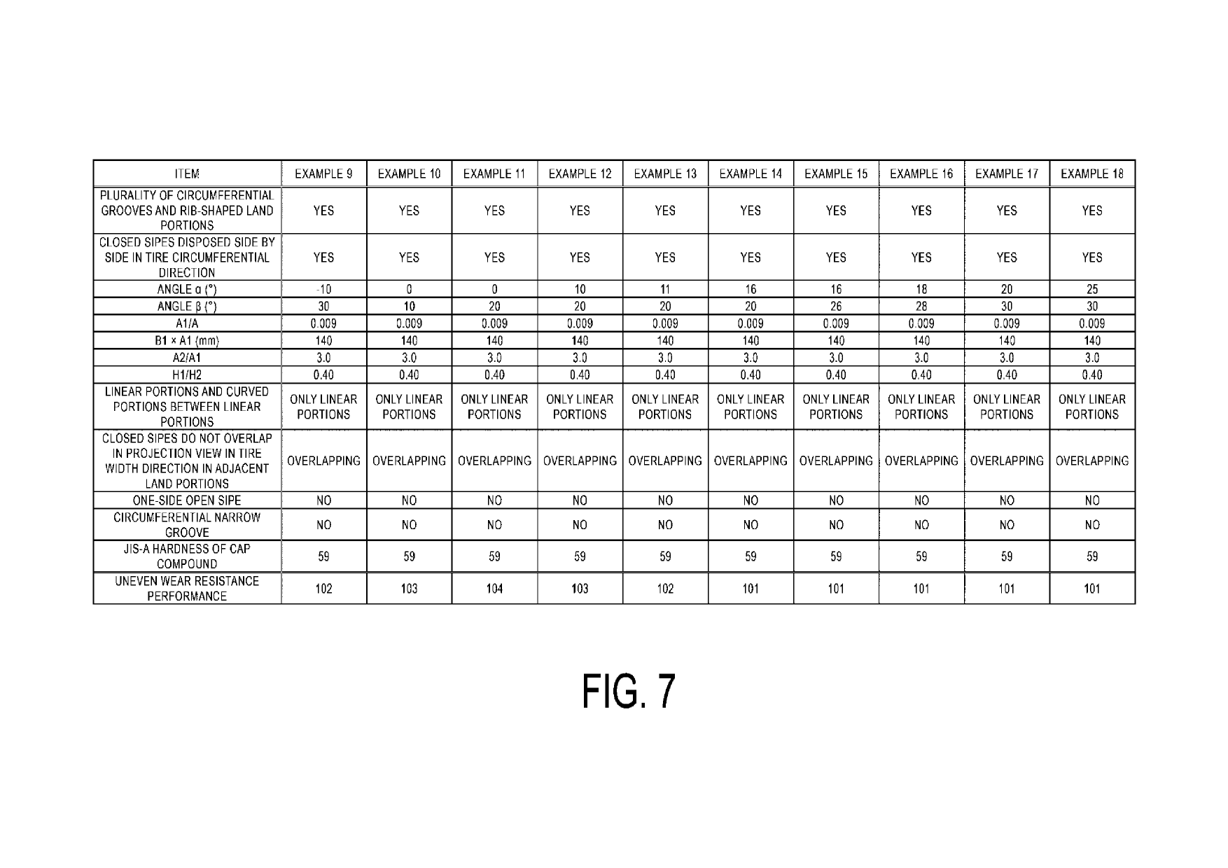

FIG. 8 is a table showing results of performance tests of pneumatic tires according to an embodiment;

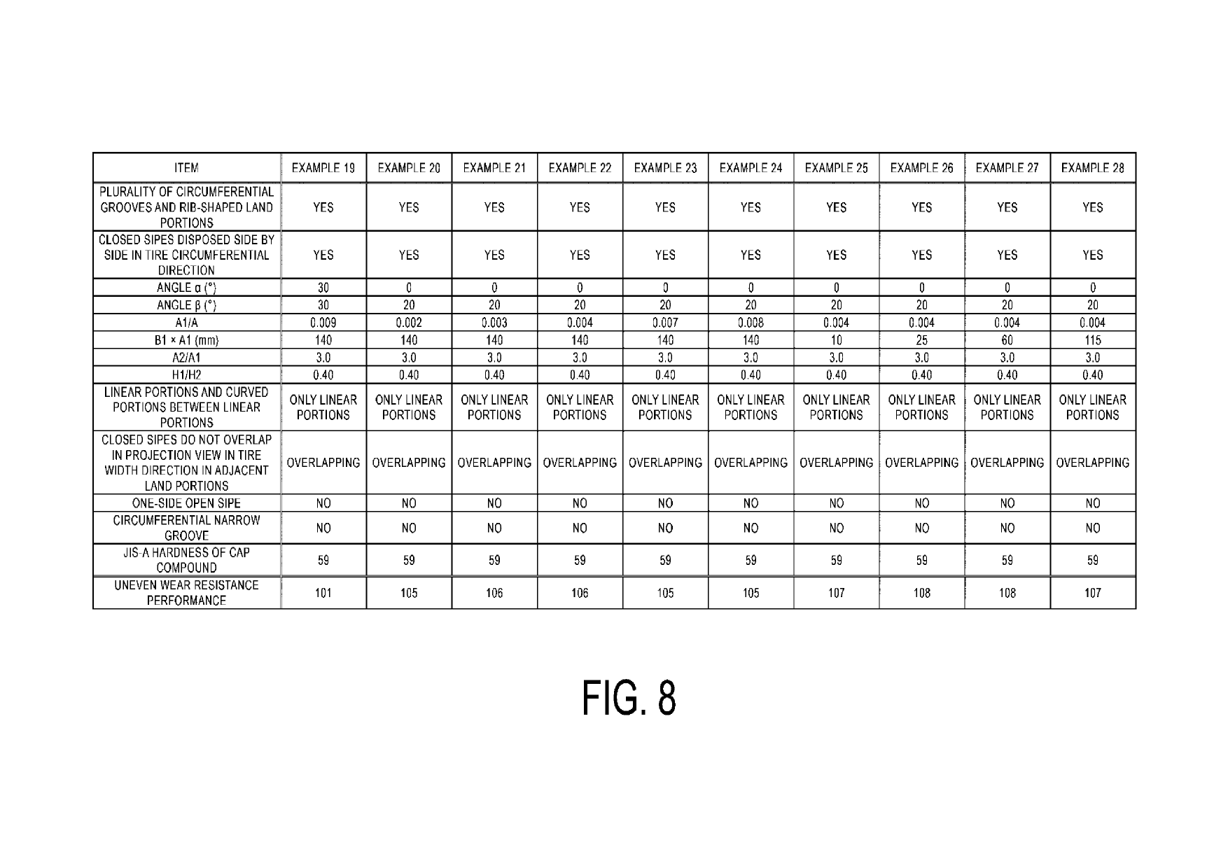

FIG. 9 is a table showing results of performance tests of pneumatic tires according to an embodiment; and,

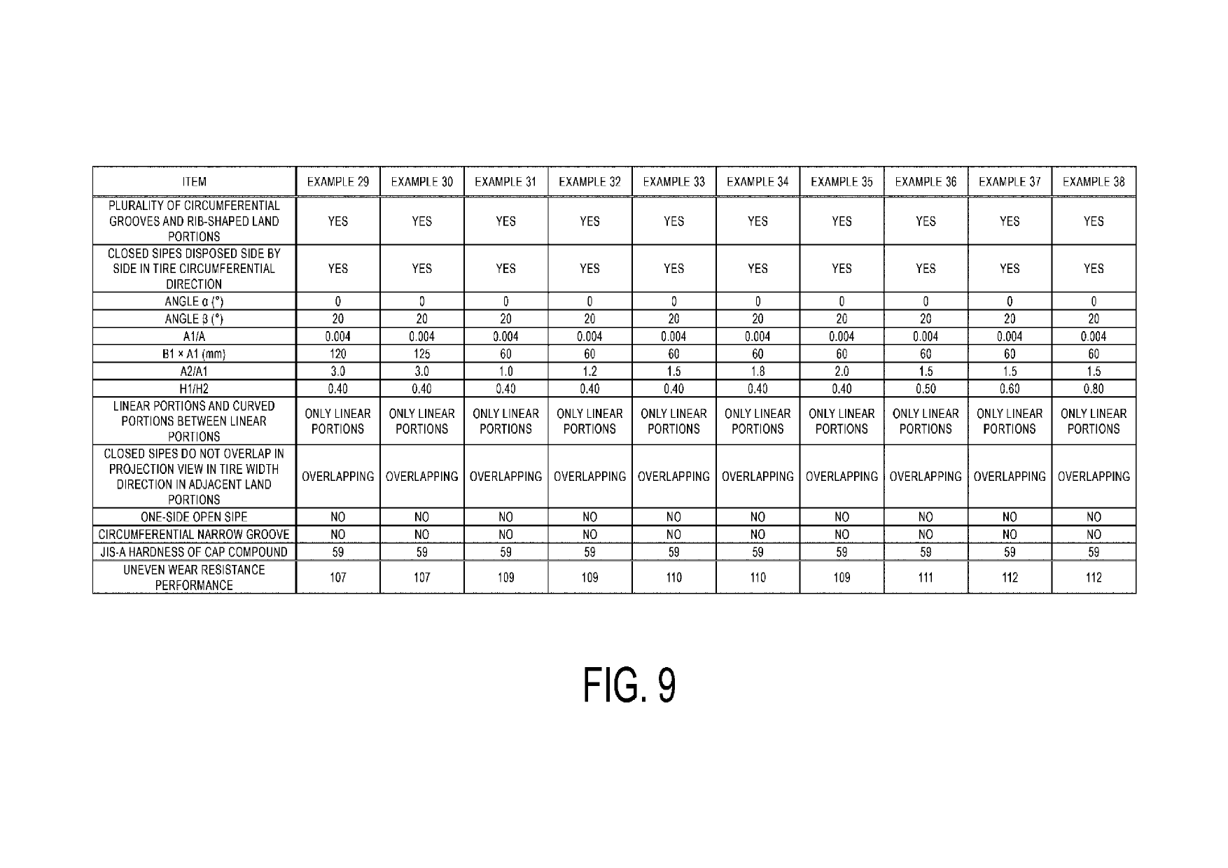

FIG. 10 is a table showing results of performance tests of pneumatic tires according to an embodiment.

### DETAILED DESCRIPTION OF THE INVENTION

An embodiment according to the present technology will be described in detail below with reference to the drawings. However, the technology is not limited to the embodiment. Constituents of the embodiment include elements that are substitutable while maintaining consistency with the technology and obviously substitutable elements. The plurality of modified examples described in the embodiment can be combined as desired within the scope apparent to one skilled in the art.

In the following description, the term "tire radial direction" refers to a direction orthogonal to the tire rotation axis (not illustrated), which is a rotation axis of a pneumatic tire 1, the term "inner side in the tire radial direction" refers to a side toward the tire rotation axis in the tire radial direction, and the term "outer side in the tire radial direction" refers to a side away from the tire rotation axis in the tire radial direction of an embodiment. The term "tire circumferential direction" refers to a circumferential direction with the tire rotation axis as a center axis. The term "tire width direction" refers to a direction parallel with the tire rotation axis, the term "inner side in the tire width direction" refers to a side toward a tire equatorial plane (tire equator line) CL in the tire width direction, and the term "outer side in the tire width direction" refers to a side away from the tire equatorial plane CL in the tire width direction. The term "tire equatorial plane CL" refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The term "tire equator line" refers to a line in the tire circumferential direction of the pneumatic tire 1 that lies on the tire equatorial plane CL. The term "cross-section in the tire meridian direction (meridian cross-sectional view)" refers to a cross section of the tire taken along a plane that includes the tire rotation axis.

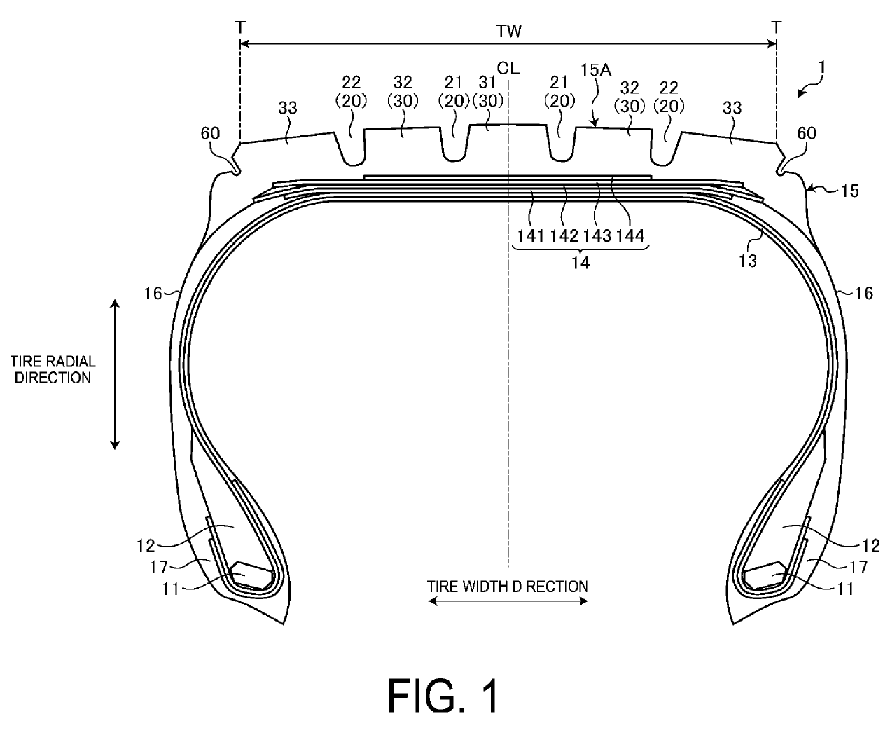

FIG. 1 is a meridian cross-sectional view of the pneumatic tire 1 according to an embodiment. In the present embodiment, a radial tire for a heavy duty vehicle, which is a tire mounted on a heavy duty vehicle and is used for long-haul operation mainly for high-speed continued traveling, will be described.

The pneumatic tire 1 of the embodiment has an annular structure with the tire rotation axis as its center and includes a pair of bead cores 11, a pair of bead fillers 12, a carcass layer 13, a belt layer 14, a tread rubber 15, a pair of sidewall rubbers 16, and a pair of rim cushion rubbers 17.

The pair of bead cores 11 include one or a plurality of bead wires made of steel and wound in an annular shape a plurality of times, respectively embedded in bead portions on both sides in the tire width direction, and constitute cores of the bead portions.

The pair of bead fillers 12 are disposed on respective outer circumferences of the pair of bead cores 11 in the tire radial direction and reinforce the bead portions.

The carcass layer 13 has a single-layer structure including one carcass ply or a multilayer structure including a plurality of carcass plies layered. In the pneumatic tire 1 of the embodiment, the carcass layer 13 is formed of one carcass ply. The carcass layer 13 extends between both bead cores in a toroidal shape, forming the framework of the tire. Both end portions of the carcass layer 13 are turned back toward outer sides in the tire width direction and fixed to wrap the bead cores 11 and the bead fillers 12. The carcass ply of the carcass layer 13 is constituted by covering, with coating rubber, a plurality of carcass cords made of steel and by performing a rolling process on the carcass cords and has a cord angle (defined as an inclination angle in a longitudinal direction of the carcass cords with respect to the tire circumferential direction) of 80° or more and 90° or less as an absolute value for a radial tire.

The belt layer 14 is formed by layering a plurality of belt plies 141 to 144 and is disposed around an outer circumference of the carcass layer 13. In these belt plies 141 to 144, belts of various configurations, such as a zero-degree belt, a large-angle belt, and a pair of cross belts are combined. The belt ply is constituted by covering, with coating rubber, a plurality of belt cords (also called wires) made of steel and by performing a rolling process on the belt cords. The zero-degree belt is defined as a belt ply in which a belt cord extends along the tire circumferential direction (for example, 0° ± 5°). The large-angle belt is defined as a belt ply in which an inclination angle of the belt cords extending with respect to the tire circumferential direction is, for example, 45° or more and 70° or less. The pair of cross belts has a so-called crossply structure in which respective belt cords have cord angles of opposite signs and are layered such that the extending directions of the belt cords cross each other.

The tread rubber 15 is disposed on an outer circumference in the tire radial direction of the carcass layer 13 and the belt layer 14 and constitutes a tread portion of the pneumatic tire 1. In the tread portion, the tread rubber 15 constitutes a tread surface 15A (also called a road contact surface) on an outer circumferential surface that comes into contact with a road surface during traveling. An end portion of the tread surface 15A on the outer side in the tire width direction is a ground contact edge T. A linear distance in the tire width direction when the tread surface 15A is developed between each ground contact edge T is defined as a ground contact width TW. The pair of sidewall rubbers 16 is each disposed on outer sides of the carcass layer 13 in the tire width direction and constitutes sidewall portions on both sides in the tire width direction of the pneumatic tire 1.

The pair of rim cushion rubbers 17 extends from an inner side in the tire radial direction of the respective bead cores 11 and the turned back portions of the carcass layer 13 toward the outer side in the tire width direction and constitutes rim fitting surfaces of the bead portions.

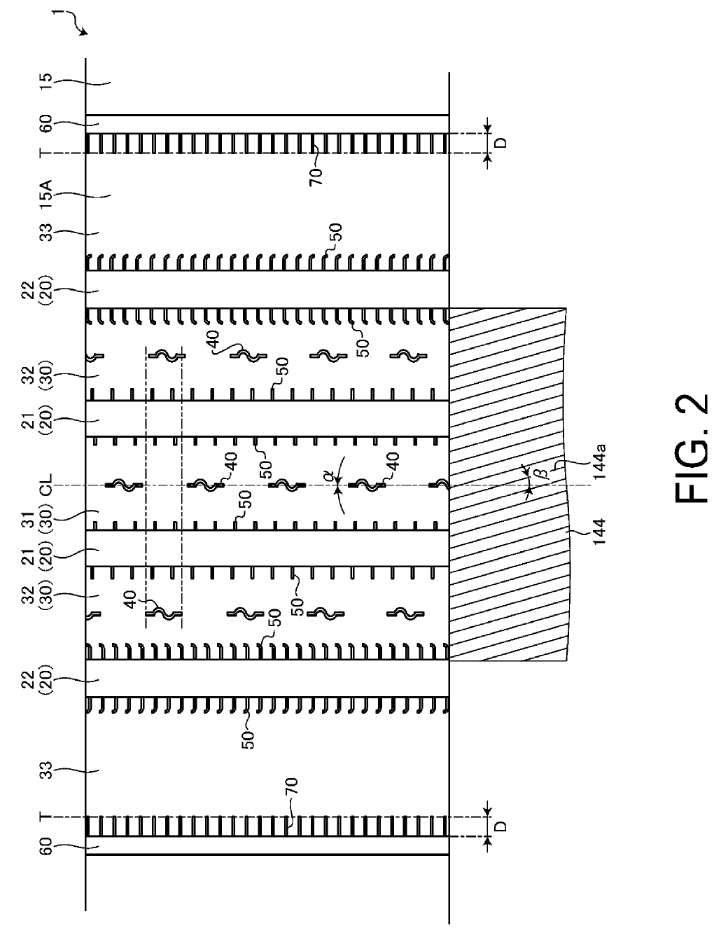

As illustrated in FIG. 2, the pneumatic tire 1 of the embodiment includes a tread pattern in the tread portion. Here, dimensions in the tread pattern are measured in an unloaded state where the pneumatic tire 1 is mounted on a specified rim and inflated to the specified internal pressure. The ground contact edge T described above is defined as a maximum width position in the tire width direction of the contact surface between the tread surface 15A and a flat plate when the tire is mounted on a specified rim, inflated to a specified internal pressure, and loaded with a load corresponding to a specified load with the tire equatorial plane CL being placed perpendicular to the flat plate.

"Specified rim" refers to a "standard rim" defined by JATMA (The Japan Automobile Tyre Manufacturers Association, Inc.), a "Design Rim" defined by the Tire and Rim Association, Inc. (TRA), or a "Measuring Rim" defined by the European Tyre and Rim Technical Organisation (ETRTO). "Specified internal pressure" refers to a "maximum air pressure" specified by JATMA, the maximum value in "TIRE LOAD LIMITS AT VARIOUS COLD INFLATION PRESSURES" specified by TRA, or "INFLATION PRESSURES" specified by ETRTO. A specified load refers to a "maximum load capacity" specified by JATMA, the maximum value in "TIRE LOAD LIMITS AT VARIOUS COLD INFLATION PRESSURES" specified by TRA, or "LOAD CAPACITY" specified by ETRTO.

The groove width is measured as a maximum value of a distance between opposed groove walls of a groove opening portion (opening end) on a surface of the tread surface 15A when the tire is mounted on a specified rim, inflated to a specified internal pressure, and in an unloaded state. In a configuration in which the groove opening portion includes a notch portion or a chamfered portion, the groove width is measured by using, as end points, intersection points of an extension line (profile) of the tread surface 15A and extension lines of the groove walls in a cross-sectional view parallel with the tire width direction and the tire radial direction.

The groove depth is measured as the maximum value of a distance from the surface of the tread surface 15A to the groove bottom when the tire is mounted on a specified rim, inflated to a specified internal pressure, and in an unloaded state. In a configuration in which partial recessed and protruding portions or a sipe is included at a groove bottom, the groove depth is measured excluding the partial recessed and protruding portions or the sipe.

As illustrated in FIGS. 1 and 2, the pneumatic tire 1 of the embodiment includes, in the tread surface 15A of the tread portion, a circumferential groove 20, a closed sipe 40, one-side open sipes 50 and 70, and a circumferential narrow groove 60.

The circumferential groove 20 is the tread portion formed by the tread rubber 15 and is disposed within the range of the ground contact width TW between each ground contact edge T. The circumferential groove 20 extends in the tire circumferential direction. At least two circumferential grooves 20 are provided side by side in the tire width direction, and four circumferential grooves 20 are provided side by side in the tire width direction in the embodiment. In the embodiment, the circumferential grooves 20 include two center circumferential grooves 21 respectively provided on both sides of the tire equatorial plane CL in the tire width direction, and two shoulder circumferential grooves 22 respectively provided on the outer sides of the center circumferential grooves 21 in the tire width direction. Each circumferential groove 20 may be defined as a groove having a wear indicator as specified by JATMA mandatorily provided.

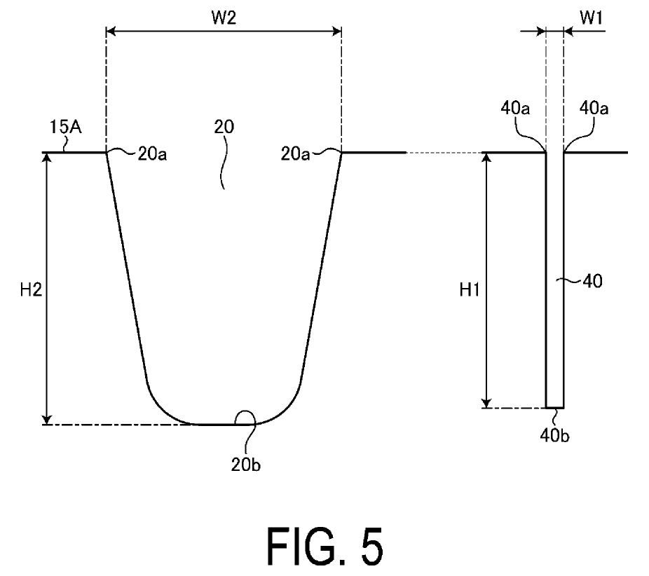

Each center circumferential groove 21 is formed having an opening end 20a (see FIG. 5) opening to the tread surface 15A and a groove bottom 20b (see FIG. 5) extending linearly along the tire circumferential direction. Each shoulder circumferential groove 22 is formed having the opening end 20a extending linearly along the tire circumferential direction and the groove bottom 20b curvilinear in the tire width direction.

The circumferential groove 20 has a groove width W2 (minimum dimension between the opening ends 20a: see FIG. 5) of 5.0 mm or more and 25.0 mm or less. The circumferential groove 20 has a groove depth H2 (minimum dimension in the tire radial direction from the opening end 20a to the groove bottom 20b: see FIG. 5) of 10.0 mm or more and 30.0 mm or less.

Each circumferential groove 20 defines land portions 31, 32, and 33 in the tire width direction. In the embodiment, the land portions 31, 32, and 33 include one row of center land portion 31 which is defined between the two center circumferential grooves 21 and is provided on the tire equatorial plane CL which is the center in the tire width direction, two rows of middle land portions 32 which are defined between each of the center circumferential grooves 21 and each of the shoulder circumferential grooves 22, and two rows of shoulder-portion land portions 33 which are defined on the outer side in the tire width direction of respective shoulder circumferential grooves 22. The center land portion 31 and each of the middle land portions 32 are also collectively defined as a center-portion land portion 30 defined on the inner side in the tire width direction of the circumferential grooves 20 (shoulder circumferential grooves 22) on the outermost side in the tire width direction.

The center land portion 31 and each of the middle land portions 32 forming the center-portion land portion 30 do not have a groove that divides the center land portion 31 and the middle land portions 32 in the tire circumferential direction and are formed in a rib shape that is continuous in the tire circumferential direction. The shoulder portion-land portion 33 does not have a groove that divides the shoulder-portion land portion 33 in the tire circumferential direction and is formed in a rib shape that is continuous in the tire circumferential direction.

Although not illustrated in the drawings, in a configuration in which the circumferential grooves 20 are five or more, six or more rows of land portions are defined, the land portions each on the outermost side in the tire width direction are the shoulder-portion land portions 33, and a plurality of rows of the land portions adjacent to each other on the inner side of each of the shoulder-portion land portions 33 in the tire width direction are the center-portion land portions 30.

The closed sipe 40 is disposed in the center land portion 31 and in each of the middle land portions 32 forming the center-portion land portion 30. The closed sipe 40 has both ends terminating at the tread surface 15A in the center land portion 31 and each of the middle land portions 32, and a plurality of the closed sipes 40 are disposed side by side in the tire circumferential direction.

The closed sipe 40 includes linear portions 41 having one end portion terminating and the other end portion formed in a linear shape and a curved portion 42 formed curvilinearly between each of the linear portions 41. The linear portions 41 are preferably arranged on the same straight line. The curved portion 42 is formed curvilinearly by a plurality of arc 42a being continuous while being inverted in the tire width direction with the center position of the arcs 42a on the opposite side in the tire width direction. In the embodiment, the curved portion 42 is formed curvilinearly in an S-shape by two arcs 42a being continuous while being inverted in the tire width direction with the center position of the arcs 42a on the opposite side in the tire width direction. In one land portion 31, 32, each closed sipe 40 is disposed side by side in the tire circumferential direction along a straight line parallel to the tire equatorial plane CL with each linear portion 41 on the straight line.

The closed sipe 40 has a width W1 (minimum dimension between opening ends 40a: see FIG. 5) of 0.1 mm or more and 3.0 mm or less. The closed sipe 40 has a depth H1 (minimum dimension in the tire radial direction from the opening end 40a to a groove bottom 40b: see FIG. 5) of 5.0 mm or more and 30.0 mm or less.

As described above, the closed sipe 40 is disposed in the center-portion land portion 30, and on the inner side of the closed sipe 40 in the tire radial direction, the belt ply 144 forming the above-described belt layer 14 on the outermost side in the tire radial direction is disposed. Therefore, the belt ply 144 on the outermost side in the tire radial direction is disposed on the inner side of all the closed sipes 40 in the tire radial direction.

The one-side open sipe 50 is formed having, in the center land portion 31, each of the middle land portions 32, and each of the shoulder-portion land portions 33, one end opening at both opening ends 20a of the circumferential groove 20 and the other end terminating at the center land portion 31, each of the middle land portions 32, and each of the shoulder-portion land portions 33. A plurality of the one-side open sipes 50 are disposed side by side in the tire circumferential direction. The one-side open sipe 50 is disposed in the range of the ground contact width TW between each ground contact edge T. The one-side open sipes 50 disposed in the center-portion land portions 30, which are the center land portion 31 and each of the middle land portions 32, are disposed linearly along the tire width direction from one end to the other end. The one-side open sipes 50 disposed in each of the shoulder-portion land portion 33 are disposed linearly along the tire direction from one end to the other end and the other end is formed curving in an arc shape. The one-side open sipe 50 has a width (minimum dimension between opening ends) of 0.1 mm or more and 3.0 mm or less. The one-side open sipe 50 has a depth (minimum dimension in the tire radial direction from the opening end to a groove bottom) of 5.0 mm or more and 30.0 mm or less. The one-side open sipe 50 has a length (minimum dimension from one end to the other end) of 2.0 mm or more and 10.0 mm or less along the tire width direction.

The circumferential narrow groove 60 is the tread portion formed by the tread rubber 15 and is disposed on the outer side in the tire width direction of each ground contact edge T in each of the shoulder-portion land portions 33. The circumferential narrow groove 60 has a groove width narrower than that of the circumferential grooves 20 and is provided linearly along the tire circumferential direction.

An interval D from the ground contact edge T to the circumferential narrow groove 60 in the tire width direction satisfies the relationship 0.005 ≤ D/TW ≤ 0.050 with respect to the ground contact width TW. The circumferential narrow groove 60 has a groove width (minimum dimension between opening ends) of 1.0 mm or more and 10.0 mm or less. The circumferential narrow groove 60 has a groove depth (minimum dimension in the tire radial direction from the opening end to a groove bottom) of 1.0 mm or more and 15.0 mm or less.

The one-side open sipe 70 is formed having, in each of the shoulder-portion land portions 33, one end opening at the opening end of the circumferential narrow groove 60 on the inner side in the tire width direction and the other end terminating at each of the shoulder-portion land portions 33. A plurality of the one-side open sipes 70 are disposed side by side in the tire circumferential direction. The one-side open sipe 70 is disposed in the range from the opening end on the inner side in the tire width direction of the circumferential narrow groove 60 to the ground contact edge T (range of the above-described interval D). The one-side open sipe 70 is disposed linearly along the tire width direction from the one end to the other end.

The one-side open sipe 70 has a width (minimum dimension between opening ends) of 0.1 mm or more and 3.0 mm or less. The one-side open sipe 70 has a depth (minimum dimension in the tire radial direction from the opening end to a groove bottom) of 1.0 mm or more and 10.0 mm or less.

The pneumatic tire 1 of the embodiment includes: as features thereof, in the tread portion, the plurality of circumferential grooves 20 extending along the tire circumferential direction and disposed side by side in the tire width direction; the center-portion land portion 30 defined by the circumferential grooves 20 and having a rib shape, the plurality of closed sipes 40 having both ends terminating at the tread surface 15A of the center-portion land portion 30 and disposed side by side in the tire circumferential direction; and the belt layer 14 composed of the plurality of belt plies 141 to 144 disposed on the inner side of the closed sipes 40 in the tire radial direction. An angle α of a straight line connecting both the ends of a closed sipe 40 of the closed sipes 40 with respect to the tire circumferential direction and a cord angle β of a belt cord 144a of the belt ply 144 on the outermost side in the tire radial direction with respect to the tire circumferential direction satisfy the relationships β - 40° ≤ α ≤ β and 10° ≤ β ≤ 30°.

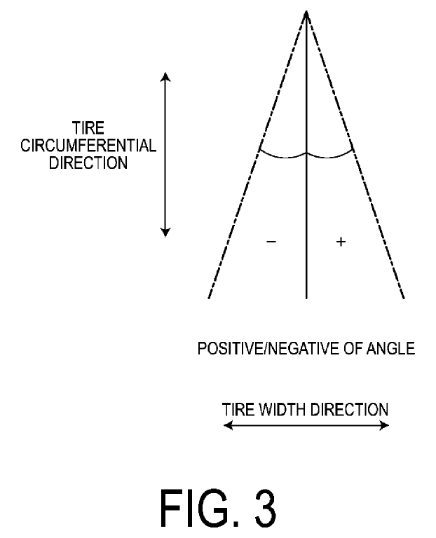

In the pneumatic tire 1 of the embodiment, the angle α of the closed sipe 40 with respect to the tire circumferential direction is an angle of a straight line connecting each end of the closed sipe 40 with respect to the tire circumferential direction. In FIG. 3, the angle α is defined as positive when the inclination is downward to the right and negative when the inclination is downward to the left, as viewed from the outer side in the tire radial direction. As illustrated in FIG. 2, the angle β is also defined as positive when the inclination is downward to the right when viewed from the outer side in the tire radial direction.

Here, if the inclination direction of the angle α of the closed sipe 40 with respect to the tire circumferential direction and the inclination direction of the cord angle β of the belt cord 144a of the belt ply 144 on the outermost side in the tire radial direction with respect to the tire circumferential direction are the same direction, the belt ply 144 is stretched in the tire circumferential direction at the time of inflation, a force acts in the inclination direction opposite to the belt cord 144a, and a force that spreads the closed sipe 40 is likely to occur when kicking out. On the other hand, if the inclination direction of the angle α of the closed sipe 40 with respect to the tire circumferential direction and the inclination direction of the cord angle β of the belt cord 144a of the belt ply 144 on the outermost side in the tire radial direction with respect to the tire circumferential direction are opposite to each other, the belt ply 144 contracts in the tire circumferential direction at the time of ground contact, a force acts in the same inclination direction as the belt cord 144a, and a force that spreads the sipe is likely to occur due to a difference in sliding amount between the bottom of the closed sipe 40 and the opening of the tread surface 15A when kicking out.

In this regard, in the pneumatic tire 1 of the embodiment, the cord angle β of the belt cord 144a of the belt ply 144 on the outermost side in the tire radial direction with respect to the tire circumferential direction is set, and the inclination angle α of the closed sipe 40 with respect to the tire circumferential direction is associated with the cord angle β, so that the closed sipe 40 is disposed so as to intersect the direction of both forces of the belt ply 144 expanding and contracting, and the force spreading in the closed sipe 40 is less likely to occur. As a result, the pneumatic tire 1 can provide improved uneven wear resistance performance.

Then, in the pneumatic tire 1, when the angle α of the closed sipe 40 is equal to or greater than the cord angle β - 40°, the stress difference between the front and rear of the sipe surface due to the belt deformation at the time of ground contact is reduced, and the uneven wear resistance is improved. In the pneumatic tire 1, when the angle α of the closed sipe 40 is equal to or less than the cord angle β, opening of the sipe due to the belt deformation during inflation is suppressed, and the uneven wear resistance is improved.

To obtain the above effect, the angle α of the closed sipe 40 and the cord angle β of the belt cord 144a of the belt ply 144 on the outermost side in the tire radial direction with respect to the tire circumferential direction preferably satisfy the relationships β - 35° ≤ α ≤ β - 5° and 12° ≤ β ≤ 28° and more preferably satisfy the relationships β - 30° ≤ α ≤ β - 10° and 14° ≤ β ≤ 26°. To obtain the above effect, the angle α of the closed sipe 40 is preferably in the range -10° ≤ α ≤ 10°. When the angle α of the closed sipe 40 and the cord angle β of the belt cord 144a of the belt ply 144 on the outermost side in the tire radial direction with respect to the tire circumferential direction are the same in absolute values, it is preferable that the inclination directions thereof are different.

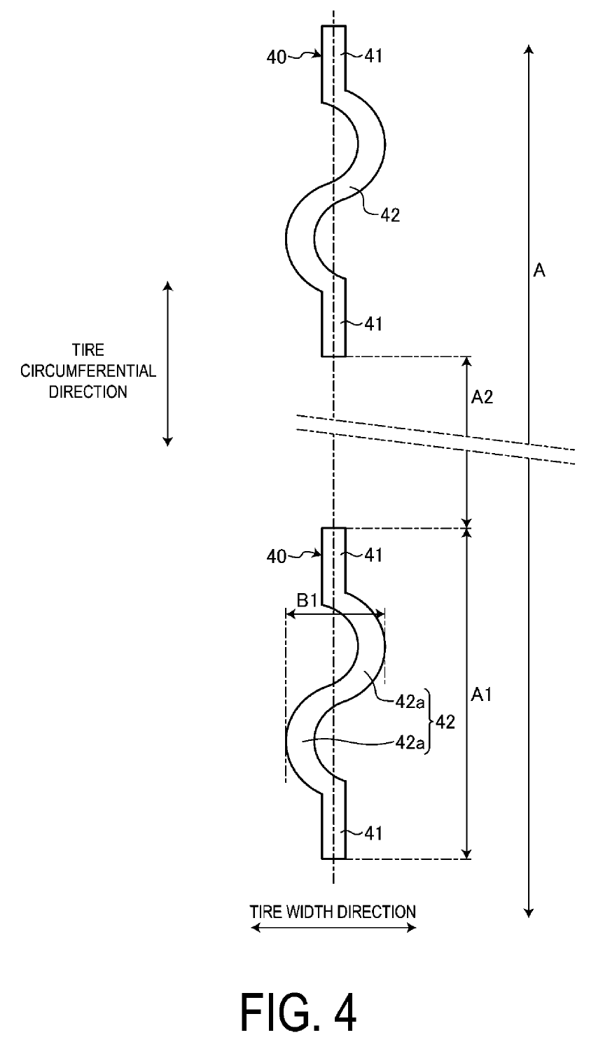

In the pneumatic tire 1, as illustrated in FIGS. 4, a length A1 between both ends of the closed sipe 40 and a tire circumferential length A of the tread surface 15A (the length of one tire circumference on the tire equatorial plane CL) satisfies the relationship 0.002 ≤ A1/A ≤ 0.008. The pneumatic tire 1 has A1/A of 0.002 or more, This effectively reduces the ground contact pressure in the center-portion land portion 30 having a rib shape and improves the uneven wear resistance. The pneumatic tire 1 has A1/A of 0.008 or less. This prevents the rigidity of the center-portion land portion 30 having a rib shape from excessively decreasing and improves the uneven wear resistance. To obtain the above effect, the pneumatic tire 1 preferably satisfies the relationship 0.003 ≤ A1/A ≤ 0.007.

In the pneumatic tire 1, as illustrated in FIG. 4, the length A1 (mm) between both ends of the closed sipe 40 and a minimum width B1 (mm) of the closed sipe 40 intersecting the length A1 satisfy the relationship 10 ≤ B1 × A1 ≤ 125.

In the relationship of B1 × A1, the closed sipe 40 is easily opened as the length A1 increases. In this regard, the pneumatic tire 1 defines the width B1 of the closed sipe 40 in accordance with the length A1 of the closed sipe 40. This can suppress the opening of the closed sipe 40 and improve the uneven wear resistance. To obtain the above-described effect, the pneumatic tire 1 preferably satisfies the relationship 25 ≤ B1 × A1 ≤ 115.

In the pneumatic tire 1, as illustrated in FIG. 4, the length A1 between both ends of the closed sipe 40 and an interval A2 between the closed sipes 40 adjacent to each other in the tire circumferential direction satisfy the relationship 1.0 ≤ A2/A1 ≤ 2.0.

The pneumatic tire 1 has A2/A1 of 1.0 or more This can avoid concentration of sections having high ground contact pressure and improves uneven wear resistance. The pneumatic tire 1 has A2/A1 of 2.0 or less. This reduces the ground contact pressure of the rib and improves the uneven wear resistance. To obtain the above effect, the pneumatic tire 1 preferably satisfies the relationship 1.2 ≤ A2/A1 ≤ 1.8.

In the pneumatic tire 1, as illustrated in FIG. 5, a depth H1 of the closed sipe 40 at the center in the tire circumferential direction and an average groove depth H2 in the tire circumferential direction of the circumferential groove 20 that defines the center-portion land portion 30 in which the closed sipe 40 is disposed excluding the wear indicator satisfy the relationship 0.50 ≤ H1/H2 ≤ 0.95.

The pneumatic tire 1 has H1/H2 of 0.50 or more. This reduces the ground contact pressure of the center-portion land portion 30 having a rib shape and improves the uneven wear resistance. The pneumatic tire 1 has H1/H2 of 0.95 or less. This prevents insufficient rigidity of the center-portion land portion 30 having a rib shape and improves the uneven wear resistance. To obtain the above effect, the pneumatic tire 1 preferably satisfies the relationship 0.60 ≤ H1/H2 ≤ 0.90.

In the pneumatic tire 1, as illustrated in FIG. 4, the closed sipe 40 includes, in the tread surface 15A, the linear portions 41 each having one end portion terminating and the other end portion, the one end portion and the other end portion being formed in a linear shape, and the curved portion 42 formed curvilinearly between each of the linear portions 41.

The pneumatic tire 1 is configured, compared to a shape that has only a straight line or a curve, the closed sipe 40, by arranging the curved portion 42 in the center of the linear portions 41 at both ends. This can define the positional relationship with the belt cord 144a of the belt ply 144 that is outermost in the tire radial direction by using each linear portion 41, and the curved portion 42 makes it less likely for the closed sipe 40 to open due to the engagement of the sipe itself with respect to the movement of the tread portion, improving uneven wear resistance.

In the pneumatic tire 1, as illustrated in FIG. 2, at least four circumferential grooves 20 are disposed side by side in the tire width direction, at least three center-portion land portions 30 having a rib shape are disposed in the tire width direction between the at least four circumferential grooves 20, and the closed sipes 40 are provided in each of the center-portion land portions 30 and are positioned not overlapping in a projection view in the tire width direction in the center-portion land portions 30 adjacent to each other in the tire width direction. In the pneumatic tire 1, the uneven wear resistance is improved by making the rigidity of the tread surface 15A in the tire width direction uniform.

As illustrated in FIG. 2, the pneumatic tire 1 further includes the plurality of one-side open sipes 50 having one end opening at an edge (the opening end 20a of the circumferential groove 20) in the tire width direction of each of the center-portion land portions 30 sandwiching the circumferential groove 20 and the other end terminating at each of the center-portion land portions 30 and disposed side by side in the tire circumferential direction. In the pneumatic tire 1, the ground contact pressure is reduced by the reduction in the rigidity of the edge of the center-portion land portion 30 having a rib shape, improving the uneven wear resistance.

As illustrated in FIGS. 1 and 2, the pneumatic tire 1 further includes, in the tread portion, the circumferential narrow groove 60 extending in the tire circumferential direction on the outer side in the tire width direction of the ground contact edge T and formed with a narrower groove width than the circumferential groove 20.

In the pneumatic tire 1, uneven wear resistance is improved by balancing rigidity in the entire tread portion including the center-portion land portion 30 and the shoulder-portion land portions 33.

As illustrated in FIG. 2, the pneumatic tire 1 preferably further includes, between the circumferential narrow groove 60 and the ground contact edge T, the plurality of one-side open sipes 70 having one end opening at the opening end of the circumferential narrow groove 60 and the other end terminating at the shoulder-portion land portion 33 and disposed side by side in the tire circumferential direction.

In the pneumatic tire 1, the ground contact pressure is reduced by the reduction in the rigidity of the edge of the rib-shaped shoulder-portion land portion 33, and the uneven wear resistance is improved.

In the pneumatic tire 1, the tread portion has JIS (Japanese Industrial Standard)-A hardness of a cap compound forming the tread surface 15A of 60 or more.

Here, JIS-A hardness is the durometer hardness measured in accordance with JIS-K6253 using a type A durometer and under a temperature of 23°C.

In the pneumatic tire 1, when the JIS-A hardness of the cap compound is relatively high, the cornering power increases, and the required slip angle decreases, so that the uneven wear resistance is improved. To obtain the above effect, the pneumatic tire 1 preferably has the JIS-A hardness of the cap compound of 63 or more.

In the present embodiment, as described above, the pneumatic tire 1 has been described as an example of a tire. The pneumatic tire 1 can be inflated with any gas including air and inert gas, such as nitrogen. However, the configuration of the tread pattern of the pneumatic tire 1 described in the present embodiment can also be applied to other tires as desired within the scope apparent to one skilled in the art. Examples of other tires include an airless tire and a solid tire.

### Examples

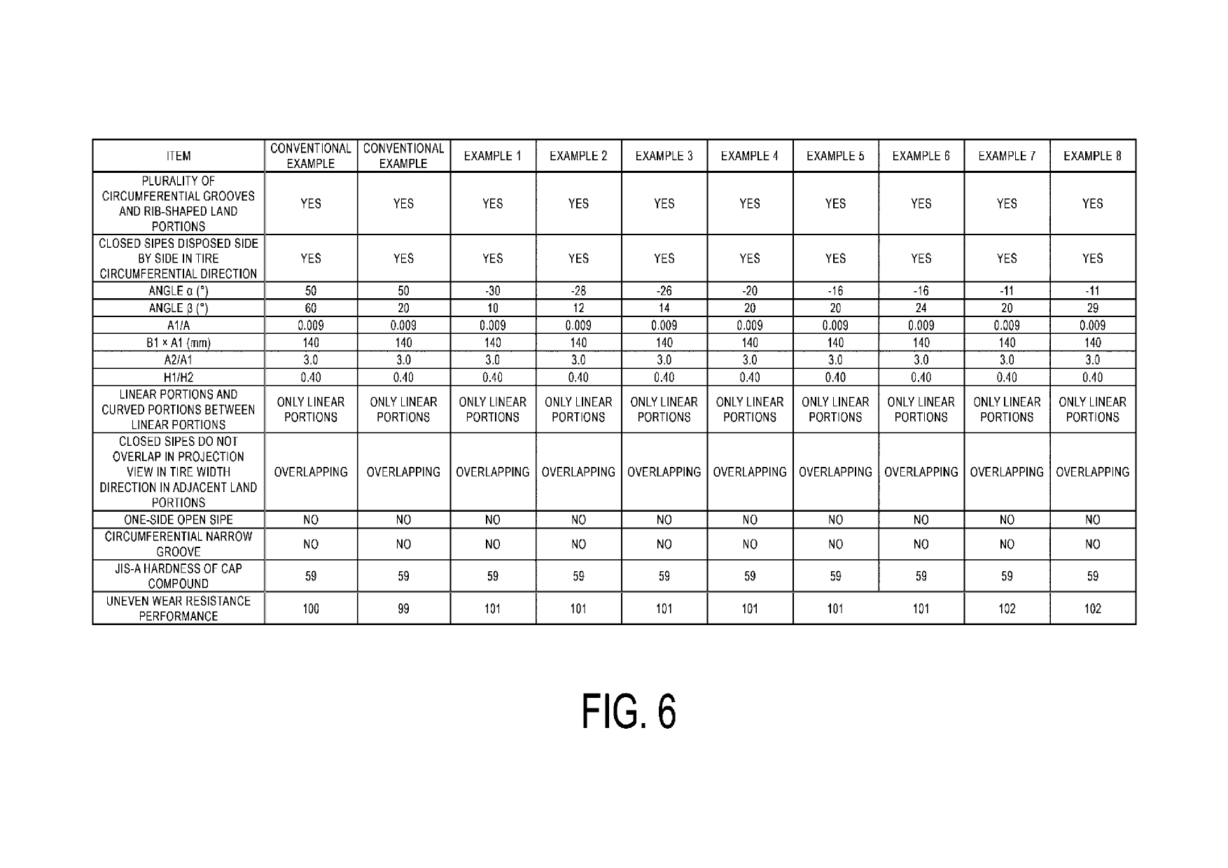

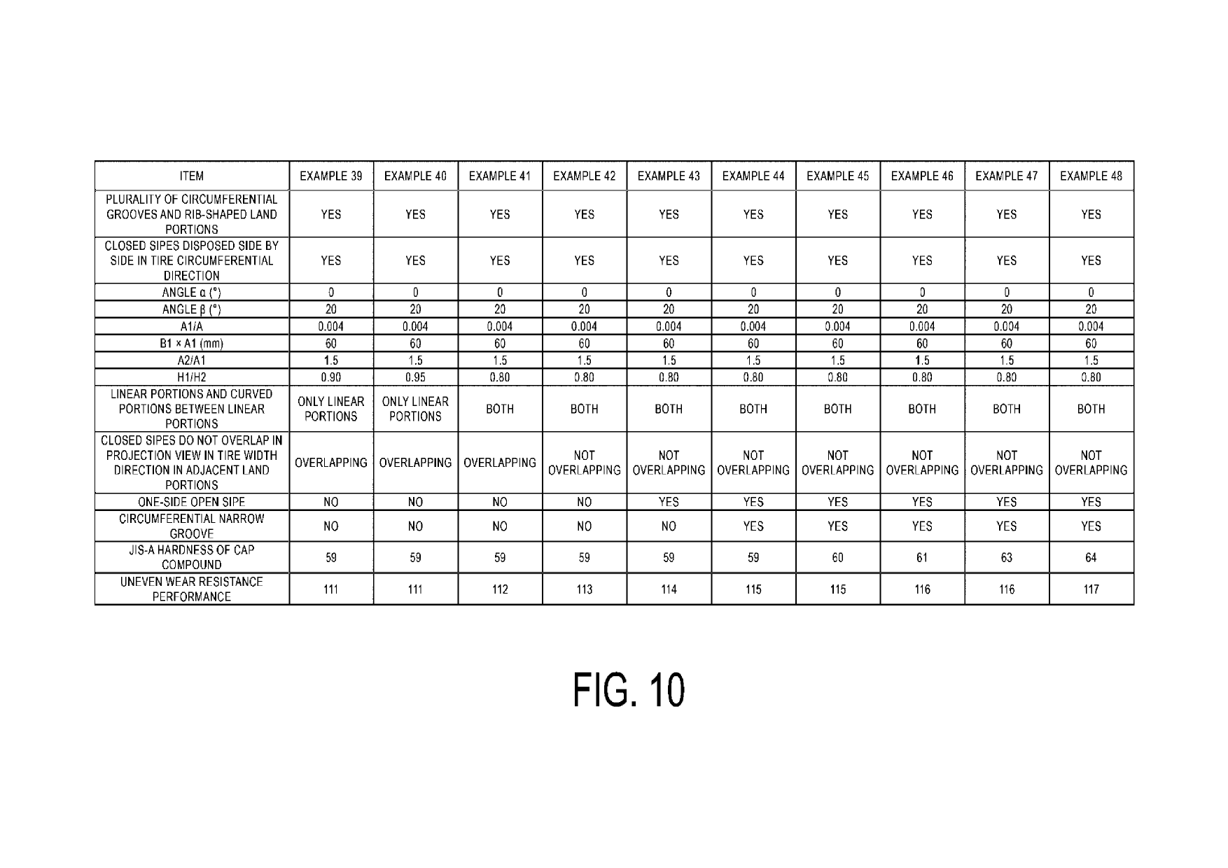

FIGS. 6 and 10 are tables showing results of performance tests of pneumatic tires according to an embodiment. Hereinafter, evaluation tests of performance conducted on pneumatic tires of Conventional Example and Comparative Example, and pneumatic tires of Examples according to the embodiment will be described. For performance evaluation tests, tests on uneven wear resistance performance were performed. The test tires had a tire size of 295/75R22.5, were mounted on a specified rim, and were inflated to a specified internal pressure.

The evaluation test of the uneven wear resistance performance is performed by visually checking the situation of uneven wear occurring between the circumferential grooves after a heavy duty vehicle equipped with the test tires travels 50000 km on express highways for 80% and general roads for 20%. Results of the evaluation are expressed as index values and evaluated with Conventional Example being assigned as the reference (100). In this evaluation, larger values are preferable.

In the pneumatic tire of the Conventional Example, in the configuration of FIGS. 1 and 2, a plurality of linear closed sipes are disposed side by side in the tire circumferential direction in the center-portion land portion, but the relationship between the angle α of the closed sipe with respect to the tire circumferential direction and the cord angle β of the belt cord of the belt ply on the outermost side in the tire radial direction with respect to the tire circumferential direction is out of the defined range.

In the pneumatic tire of the Comparative Example, in the configuration of FIGS. 1 and 2, a plurality of linear closed sipes are disposed side by side in the tire circumferential direction in the center-portion land portion, but the angle α of the closed sipe with respect to the tire circumferential direction is out of the defined range.

In the pneumatic tire of the Examples, in the configuration of FIGS. 1 and 2, a plurality of linear closed sipes are disposed side by side in the tire circumferential direction in the center-portion land portion, the relationship between the angle α of the closed sipe with respect to the tire circumferential direction and the cord angle β of the belt cord of the belt ply on the outermost side in the tire radial direction with respect to the tire circumferential direction is within the defined range.

As can be seen from the test results, in the pneumatic tires of the Examples, uneven wear resistance performance is improved with respect to the Conventional Example and the Comparative Example.

The present disclosure includes the following technologies.

### Technology 1

A tire, including:

in a tread portion, a plurality of circumferential grooves extending along a tire circumferential direction and disposed side by side in a tire width direction;

a land portion defined by the circumferential grooves and having a rib shape;

a plurality of closed sipes having both ends terminating at the tread surface of the land portion and disposed side by side in the tire circumferential direction; and,

a belt layer composed of a plurality of belt plies disposed on an inner side of the closed sipes in a tire radial direction;

an angle α of a straight line connecting both the ends of each of the closed sipes with respect to the tire circumferential direction and a cord angle β of a belt cord of a belt ply of the belt plies on an outermost side in the tire radial direction with respect to the tire circumferential direction satisfying relationships β - 40° ≤ α ≤ β and 10° ≤ β ≤ 30°.

### Technology 2

The tire according to Technology 1, wherein a length A1 between both the ends of the closed sipe and a tire circumferential length A of the tread surface satisfy a relationship 0.002 ≤ A1/A ≤ 0.008.

### Technology 3

The tire according to Technology 1 or 2, wherein a length A1 between both the ends of the closed sipe and a minimum width B1 of the closed sipe intersecting the length A1 satisfy a relationship 10 ≤ B1 × A1 ≤ 125.

### Technology 4

The tire according to any one of Technologies 1 to 3, wherein a length A1 between both the ends of the closed sipe and an interval A2 between the closed sipes adjacent to each other in the tire circumferential direction satisfy a relationship 1.0 ≤ A2/A1 ≤ 2.0.

### Technology 5

The tire according to any one of Technologies 1 to 4, wherein a depth H1 of the closed sipe at a center in the tire circumferential direction and an average groove depth H2 of the circumferential groove that defines the land portion in which the closed sipe is disposed satisfy a relationship 0.50 ≤ H1/H2 ≤ 0.95.

### Technology 6

The tire according to any one of Technologies 1 to 5, wherein the closed sipe includes, in the tread surface, linear portions each having one end portion terminating and the other end portion, the one end portion and the other end portion being formed in a linear shape, and a curved portion formed curvilinearly between the linear portions.

### Technology 7

The tire according to any one of Technologies 1 to 6, wherein

at least four of the circumferential grooves are disposed side by side in the tire width direction;

at least three of the land portions each having a rib shape are disposed side by side in the tire width direction between the at least four of the circumferential grooves; and,

the closed sipes are provided in each of the land portions and are positioned not overlapping in a projection view in the tire width direction in the land portions adjacent to each other in the tire width direction.

### Technology 8

The tire according to any one of Technologies 1 to 7, further including: a plurality of one-side open sipes having one end opening at an edge in the tire width direction of each of the land portions sandwiching the circumferential grooves and the other end terminating at each of the land portions and disposed side by side in the tire circumferential direction.

### Technology 9

The tire according to any one of Technologies 1 to 8, further including in the tread portion, a circumferential narrow groove extending in the tire circumferential direction on the outer side in the tire width direction of a ground contact edge and formed with a narrower groove width than the circumferential groove.

### Technology 10

The tire according to any one of Technologies 1 to 9, wherein the tread portion has JIS-A hardness of a cap compound of 60 or more.

What is claimed is:

1. A tire, comprising:
in a tread portion, a plurality of circumferential grooves extending along a tire circumferential direction and disposed side by side in a tire width direction;
a land portion defined by the circumferential grooves and having a rib shape;
a plurality of closed sipes having both ends terminating at the tread surface of the land portion and disposed side by side in the tire circumferential direction;
a belt layer composed of a plurality of belt plies disposed on an inner side of the closed sipes in a tire radial direction; and,
an angle α of a straight line connecting both the ends of a closed sipe of the closed sipes with respect to the tire circumferential direction and a cord angle β of a belt cord of a belt ply of the belt plies on an outermost side in the tire radial direction with respect to the tire circumferential direction satisfying relationships β - 40° ≤ α ≤ β and 10° ≤ β ≤ 30°.

2. The tire according to claim 1, wherein a length A1 between both the ends of the closed sipe and a tire circumferential length A of the tread surface satisfy a relationship 0.002 ≤ A1/A ≤ 0.008.

3. The tire according to claim 1, wherein a length A1 between both the ends of the closed sipe and a minimum width B1 of the closed sipe intersecting the length A1 satisfy a relationship 10 ≤ B1 × A1 ≤ 125.

4. The tire according to claim 1, wherein a length A1 between both the ends of the closed sipe and an interval A2 between the closed sipes adjacent to each other in the tire circumferential direction satisfy a relationship 1.0 ≤ A2/A1 ≤ 2.0.

5. The tire according to claim 1, wherein a depth H1 of the closed sipe at a center in the tire circumferential direction and an average groove depth H2 of the circumferential groove that defines the land portion in which the closed sipe is disposed satisfy a relationship 0.50 ≤ H1/H2 ≤ 0.95.

6. The tire according to claim 1, wherein the closed sipe comprises, in the tread surface, linear portions each having one end portion terminating and the other end portion, the one end portion and the other end portion being formed in a linear shape, and a curved portion formed curvilinearly between the linear portions.

7. The tire according to claim 1, wherein
at least four of the circumferential grooves are disposed side by side in the tire width direction;
at least three of the land portions each having a rib shape are disposed side by side in the tire width direction between the at least four of the circumferential grooves; and,
the closed sipes are provided in each of the land portions and are positioned not overlapping each other in a projection view in the tire width direction in the land portions adjacent to each other in the tire width direction.

8. The tire according to claim 1, further comprising
a plurality of one-side open sipes having one end opening at an edge in the tire width direction of each of the land portions sandwiching the circumferential grooves and the other end terminating at each of the land portions and disposed side by side in the tire circumferential direction.

9. The tire according to claim 1, further comprising
in the tread portion, a circumferential narrow groove extending in the tire circumferential direction on an outer side in the tire width direction of a ground contact edge and formed with a narrower groove width than the circumferential groove.

10. The tire according to claim 1, wherein the tread portion has JIS-A hardness of a cap compound of 60 or more.
